(19) United States
(12) Patent Application Publication
(10) Pub. No.: US 2026/0259131 A1
(43) Pub. Date: Sep. 3, 2026

(54) CELL INFORMATION ACQUISITION SYSTEM AND CELL INFORMATION ACQUISITION METHOD

(71) Applicant: CANON KABUSHIKI KAISHA, Tokyo (JP)

(72) Inventors: HARUKA MAEOKA, Tokyo (JP); YOSHIKATSU ICHIMURA, Tokyo (JP); YOJI YAMAMOTO, Tokyo (JP); TAKUSHI ICHINOO, Tokyo (JP)

(21) Appl. No.: 19/549,352

(22) Filed: Feb. 25, 2026

(30) Foreign Application Priority Data
Feb. 28, 2025 (JP) 2025-032149

(51) Int. Cl. G01N 21/21; G01N 21/01; G02B 5/30

(52) U.S. Cl. CPC G01N 21/21; G01N 21/01; G02B 5/3025

(57) ABSTRACT

The cell information acquisition system includes: a holding unit including an observation surface, the holding unit being configured to hold a sample containing a cell on the observation surface; a first light irradiation unit configured to irradiate the observation surface with parallel light; an image pickup unit being configured to receive side-scattered light from the cell; a mounting unit for a first polarization unit that is configured to selectively transmit at least part of the irradiation light in a first polarization direction; and a mounting unit for a second polarization unit that is configured to selectively transmit at least part of light from the sample in a second polarization direction perpendicular to the first polarization direction. The image pickup unit is arranged at a position at which specularly reflected light of the irradiation light is not incident on the image pickup element.

### BACKGROUND

### Field of the Technology

The present disclosure relates to a cell information acquisition system and a cell information acquisition method.

### Description of the Related Art

In a cell-related field, cell images or the like are acquired through use of an observation apparatus that utilizes an optical system such as a microscope, and characteristics of cells are evaluated.

In Japanese Patent Laid-Open No. 2020-173473, there is disclosed, in regard to a microscope that observes forward-scattered light from cells, a configuration in which polarizing plates on a light source side and an image pickup element side are mounted such that polarization directions thereof are perpendicular to each other in order to reduce transmitted light and reflected light.

Further, in U.S. Patent Application Publication No. 2024/0137637, there is disclosed, in regard to an image pickup apparatus that acquires images of phase objects such as cells, a configuration in which excitation light is applied to an object from an oblique direction in order to reduce transmitted light and reflected light that enter an image pickup element.

The technology as described in Japanese Patent Laid-Open No. 2020-173473 is for observing forward-scattered light, and hence a light source, an object, and an image pickup element are present on a common axis. Thus, when the configuration as described in Japanese Patent Laid-Open No. 2020-173473 is used to observe side-scattered light from cells, the configuration easily allows transmitted light, reflected light, and forward-scattered light to enter the image pickup element, and hence there is a problem in that it is difficult to acquire an image of side-scattered light at a high signal-to-noise (S/N) ratio.

Further, in the technology as described in U.S. Patent Application Publication No. 2024/0137637, suppression of entry of light components other than side-scattered light, such as reflected light, into the image pickup element is not sufficient, and hence there is a problem in that it is difficult to acquire an image formed of side-scattered light.

### SUMMARY

In view of the foregoing, according to the present disclosure, it is possible to analyze a sample containing cells with high accuracy. In order to solve the problems described above, according to one aspect of the present disclosure, there is provided a cell information acquisition system including: a holding unit including an observation surface that is light-transmittable, the holding unit being configured to hold a sample containing a cell on the observation surface; a first light irradiation unit configured to irradiate the observation surface with irradiation light that is parallel light; an image pickup unit including an image pickup element, the image pickup unit being configured to receive side-scattered light from the cell and pick up an image of the side-scattered light; a first polarization unit arranged between the observation surface and the first light irradiation unit, and configured to selectively transmit light in a first polarization direction, the light being at least part of the irradiation light; and a second polarization unit arranged between the observation surface and the image pickup unit, and configured to selectively transmit light in a second polarization direction perpendicular to the first polarization direction, the light being at least part of light from the sample, wherein the image pickup unit is arranged at a position at which specularly reflected light of the irradiation light is not incident on the image pickup element, the position being located on the same side as a side on which the first light irradiation unit is arranged with reference to a plane including the observation surface.

Further, according to another aspect of the present disclosure, there is provided a cell information acquisition method including: a light irradiation step of irradiating an observation surface that is light-transmittable and that holds a sample containing a cell with irradiation light that is parallel light through a first polarization unit configured to selectively transmit light in a first polarization direction; and an image pickup step of receiving light including side-scattered light from the cell that has passed through a second polarization unit configured to selectively transmit light in a second polarization direction perpendicular to the first polarization direction, at a position at which specularly reflected light of the irradiation light is not received, on the same side as a side from which light is emitted in the light irradiation step with reference to the observation surface.

According to the present disclosure, it is possible to provide the cell information acquisition system and the cell information acquisition method that enable, for a sample containing cells, acquisition and analysis of side-scattered light signals from the cells with high accuracy.

Features of the present disclosure will become apparent from the following description of embodiments with reference to the attached drawings. The following description of embodiments is described by way of example.

### BRIEF DESCRIPTION OF THE DRAWINGS

FIG. 1A is a functional block diagram for illustrating an example of a configuration of a cell information acquisition system according to a first embodiment.

FIG. 1B is a functional block diagram for illustrating an example of a configuration in which the cell information acquisition system according to the first embodiment includes mounting units for first and second polarization units.

FIG. 2 is a schematic view for illustrating an example of an overall apparatus configuration of the cell information acquisition system according to the first embodiment.

FIG. 3 is an explanatory schematic view for illustrating an example of arrangement of a first light irradiation unit and an image pickup unit with reference to a plane including an observation surface in the cell information acquisition system according to the present disclosure.

FIG. 4 is a flow chart for illustrating a flow of a cell information acquisition method according to the first embodiment.

FIG. 5 is a functional block diagram for illustrating an example of a configuration of a cell information acquisition system according to a second embodiment.

FIG. 6 is a schematic view for illustrating an example of an overall apparatus configuration of the cell information acquisition system according to the second embodiment.

FIG. 7 is a flow chart for illustrating a flow of a cell information acquisition method according to the second embodiment.

FIG. 8A is an image for showing a side-scattered light image in an Example acquired through use of the cell information acquisition system according to the present disclosure.

FIG. 8B is an image for showing a side-scattered light image in a Reference Example.

FIG. 9A is an image for showing a scattering intensity of a cell in the Example of the present disclosure.

FIG. 9B is an image for showing a scattering intensity of a cell in the Reference Example of the present disclosure.

FIG. 9C is a graph for showing a scattering intensity profile of the cell in the Example of the present disclosure.

FIG. 9D is a graph for showing a scattering intensity profile of the cell in the Reference Example of the present disclosure.

FIG. 10 is a histogram for showing results of analyzing a scattering intensity of cell groups.

FIG. 11A is a radar chart for showing a result of analyzing a scattering pattern of a cell group.

FIG. 11B is a radar chart for showing a result of analyzing a scattering pattern of a cell group.

### DESCRIPTION OF THE EMBODIMENTS

Embodiments according to the present disclosure are now described with reference to the drawings. Like elements or corresponding elements are denoted by the same reference numerals in the drawings, and description thereof may be omitted or simplified.

A sample described in the present disclosure is not limited to a sample containing cells, and a system and a method according to the present disclosure are also applicable to a sample containing other fine particles having a size comparable to that of cells. An example of using a sample containing cells as an object is described below.

### First Embodiment

### <Cell Information Acquisition System>

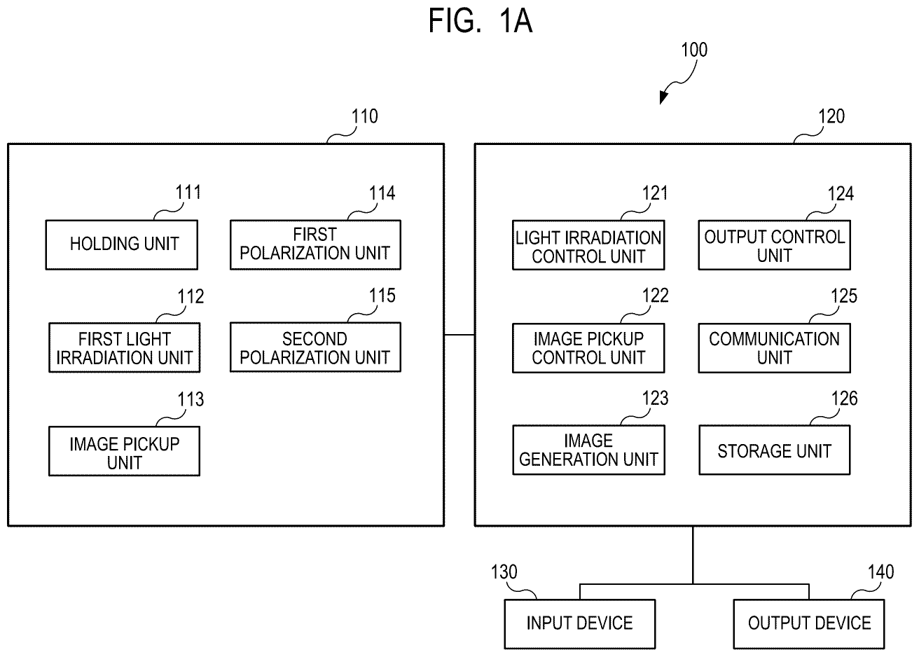

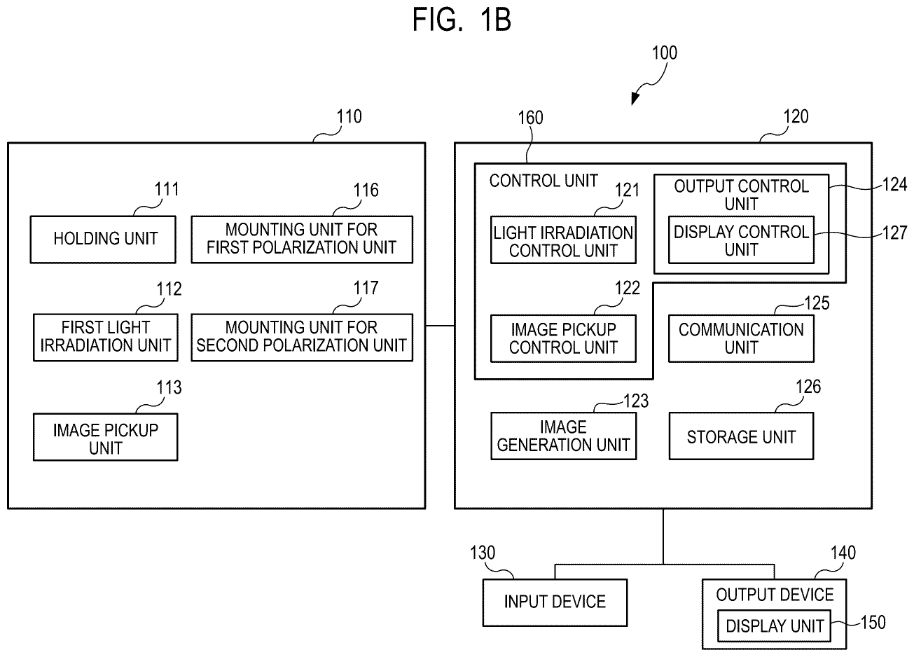

FIG. 1A and FIG. 1B are functional block diagrams for illustrating examples of a configuration of a cell information acquisition system according to a first embodiment.

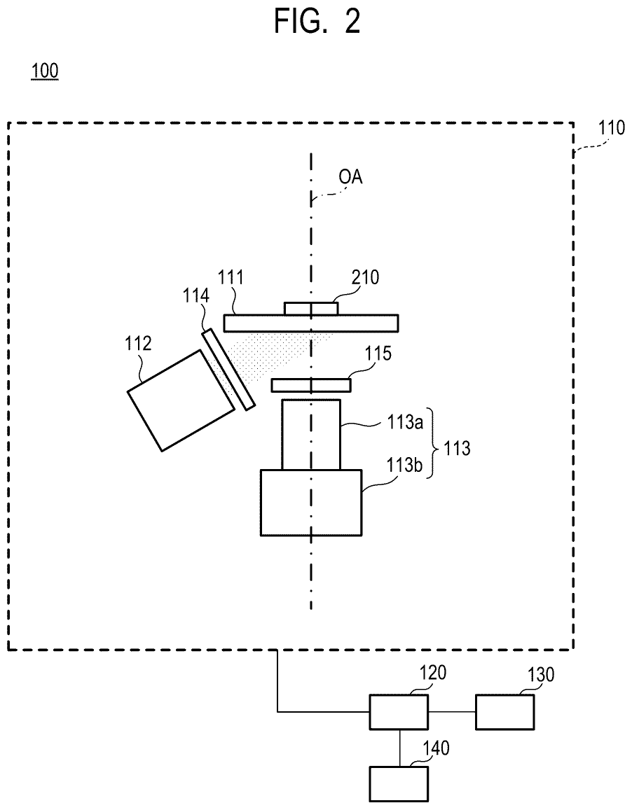

FIG. 2 is a schematic view for illustrating an example of an apparatus configuration of the cell information acquisition system according to the first embodiment.

A cell information acquisition system 100 illustrated in FIG. 1A includes an image acquisition apparatus 110, an information processing device 120, an input device 130, and an output device 140.

The image acquisition apparatus 110 includes a holding unit 111, a first light irradiation unit 112, an image pickup unit 113, a first polarization unit 114, and a second polarization unit 115. The first polarization unit 114 and the second polarization unit 115 may be controlled such that a control unit 160 of the information processing device 120 arranges the first polarization unit 114 between an observation surface described later and the first light irradiation unit 112 and arranges the second polarization unit 115 between the observation surface and the image pickup unit 113. Alternatively, the image acquisition apparatus 110 may include, as illustrated in FIG. 1B, a mounting unit 116 for the first polarization unit 114 and a mounting unit 117 for the second polarization unit 115, and a user may manually mount the first polarization unit 114 in the mounting unit 116 for the first polarization unit 114 and manually mount the second polarization unit 115 in the mounting unit 117 for the second polarization unit 115.

Further, the information processing device 120 includes a light irradiation control unit 121, an image pickup control unit 122, an image generation unit 123, an output control unit 124, a communication unit 125, and a storage unit 126.

As illustrated in FIG. 2, the image acquisition apparatus 110, the input device 130, and the output device 140 are connected to the information processing device 120 through wired communication or wireless communication so as to enable communication therebetween.

The image acquisition apparatus 110 is an optical apparatus configured to apply light to a sample held by the holding unit 111 from the first light irradiation unit 112 and further pick up an image of cells or the like contained in the sample by the image pickup unit 113. Details of respective elements forming the image acquisition apparatus 110 are described later.

Further, the information processing device 120 has computer functions, and is configured to be able to control the image acquisition apparatus 110. For example, the information processing device 120 may be configured integrally with a desktop personal computer (PC), a laptop PC, a tablet terminal, a smartphone, or the like.

The information processing device 120 may include, as a processor for implementing functions as a computer that performs arithmetic and logic operations and storage, a central processing unit (CPU), a micro controller unit (MPU), a random access memory (RAM), a graphics processing unit (GPU), an application specific integrated circuit (ASIC), a field programmable gate array (FPGA), or the like. Functions of the light irradiation control unit 121, the image pickup control unit 122, the image generation unit 123, and the output control unit 124 are implemented by the functions of the processor included in the information processing device 120.

The light irradiation control unit 121 controls an operation of the first light irradiation unit 112 included in the image acquisition apparatus 110, and the image pickup control unit 122 controls an operation of the image pickup unit 113 included in the image acquisition apparatus 110.

The image generation unit 123 generates an image based on a signal acquired through image pickup by the image pickup unit 113.

Further, the output control unit 124 controls output of information regarding the cells acquired based on the signal acquired through image pickup by the image pickup unit 113, to the output device 140.

The communication unit 125 is a functional portion for performing communication between the information processing device 120 and an external apparatus, and is typically formed of a communication interface (I/F). Examples of the communication I/F include USB (trademark), HDMI (trademark), and Ethernet (trademark) (LAN) for wired communication, and Wi-Fi (trademark), Bluetooth (trademark), and NFC (near-field communication) for wireless communication. The information processing device 120 is connected to the image acquisition apparatus 110, the input device 130, and the output device 140 through the communication unit 125 so as to enable communication therebetween. The information processing device 120 can also be used by being connected, through the communication unit 125, to a cloud, a server, or another apparatus on the Internet.

The storage unit 126 is a storage medium for storing each program to be used for processing by a processor in the information processing device 120, image information acquired by the image acquisition apparatus 110, and the like. Both a non-volatile storage medium and a volatile storage medium can be used as the storage unit 126. Specific examples of the volatile storage medium include a random access memory (RAM). Specific examples of the non-volatile storage medium further include a hard disk drive (HDD), an optical disc, a magneto-optical disk, and a solid state drive (SSD), a read only memory (ROM). The information processing device 120 may be connected to an external storage device through the communication unit 125 in place of the storage unit 126 or together with the storage unit 126.

The input device 130 is a device for inputting information to the information processing device 120, and is typically a user interface for the user to operate the information processing device 120. Examples of the input device 130 include a keyboard, a button, a mouse, and a touch panel.

The output device 140 is a device for outputting information from the information processing device 120 in a manner recognizable to the user, and is typically a user interface for presenting information to the user. Examples of the output device 140 include a display and a speaker.

The input device 130 and the output device 140 may be configured integrally with the information processing device 120 as in a case of a touch panel terminal.

The image acquisition apparatus 110 includes a mode (hereinafter referred to as “autofluorescence mode”) for picking up an image of autofluorescence, namely, a first photographing mode, and a side-scattered light mode for picking up an image of side-scattered light, namely, a second photographing mode, and the autofluorescence mode may be a default mode (initial state). The user can select a mode in accordance with information to be acquired. The user selects the default mode in a case of acquiring information relating to a metabolic state of cells, and selects the side-scattered light mode in a case of acquiring information relating to complexity of an internal structure.

The output device 140 may include a display unit 150, and a GUI may be displayed on the display unit 150 under control of a display control unit 127 included in the output control unit 124. The user can perform mode switching by operating the GUI displayed on the display unit 150. Display of the GUI on the output device 140 is controlled by the display control unit 127. The display control unit 127 may display a mode switching button (an operation region for receiving switching of a photographing mode) together with information relating to a currently selected photographing mode. In this case, a configuration in which the output device 140 includes the display unit 150 is described, but the display unit 150 may not be present in the cell information acquisition system, and the GUI may be displayed on a display unit outside the cell information acquisition system.

The GUI displayed on the output device 140 may include a side-scattered light mode selection button for switching to the side-scattered light mode, an autofluorescence mode selection button for returning to the initial state, a name of a currently selected mode, an information display region for displaying information relating to image pickup, an information input region for inputting and changing a desired numerical value with respect to the information displayed in the information display region, an image display region for displaying a live image and a picked-up still image, a live image start button, and an image pickup button. The information display region and the information input region may be integrated.

When the side-scattered light mode selection button is pressed by the user, a polarizer is automatically inserted on a light path, and “side-scattered light mode selected” is displayed in a display region together with camera image pickup conditions such as an exposure time and ISO and an insertion state (ON) of the polarizer. When a default selection button is pressed, the polarizer is removed from the light path, “default mode selected” is displayed in the display region, and information such as an exposure time, ISO, a wavelength of light to be applied, a filter to be used, an insertion state (ON or OFF) of the polarizer, and a camera sensor position is displayed. Information displayed in the information display region can be changed by inputting a desired value into the information input region.

After switching to a desired mode, when the live image start button is pressed, a live image is displayed in the image display region, and when the image pickup button is further pressed, the live image in the image display region is switched to a picked-up still image. Even when the image pickup button is pressed under a state in which the live image start button has not been pressed, a still image picked up at that time is displayed in the image display region. Further, the image pickup button can be pressed any number of times, and the most recent still image is displayed in the image display region.

In addition, an image re-display button for re-displaying an image picked up in the past in the image display region may be provided. When the image re-display button is pressed, a list of images picked up in the past is displayed, and the user can select therefrom an image to be re-displayed. All buttons may be configured to be pressed by a touch operation, a click operation, or another operation.

Next, respective elements forming the image acquisition apparatus 110 are described.

### (Holding Unit 111)

The holding unit 111 includes a light-transmittable observation surface (not shown), and is a portion capable of holding a sample 210 containing cells on the observation surface.

The sample 210 containing cells may be held by the holding unit 111 while being accommodated in a plastic container or the like, and may alternatively be held by being placed directly on the holding unit 111. When the sample 210 containing cells is accommodated in a container or the like, a bottom surface of the container that is in contact with the observation surface is required to be made of a light-transmittable material.

The observation surface is preferred to be a flat surface, and when the sample 210 containing cells is accommodated in the container, the bottom surface of the container that is in contact with the observation surface is also preferred to be a flat surface.

The container accommodating the sample 210 containing cells is also preferred to be held so as not to move from a placement position on the holding unit 111. Thus, a fixing jig or the like may be provided so as to prevent the container accommodating the sample 210 containing cells from moving from the placement position on the holding unit 111 due to an impact.

The holding unit 111 can be configured as a two-axis XY stage, and an image pickup position may be changed by moving the XY stage. In a case in which the holding unit 111 is configured as a movable two-axis XY stage, different wells can be photographed when a multiwell plate is used as the container accommodating the sample 210 containing cells.

For driving of the holding unit 111, a manual method or a method of controlling the holding unit 111 as an automatic stage by the information processing device 120 or the like may be employed. Further, under a state in which a position of the holding unit 111 is fixed, the photographing position of the sample 210 containing cells may be changed by moving the first light irradiation unit 112 or the image pickup unit 113.

The observation surface of the holding unit 111 positioned between the first light irradiation unit 112 or the image pickup unit 113 and the sample 210 containing cells is required to have a region made of an optically transparent structure. For example, when 90% or more of visible light within a range of from about 380 nm to about 750 nm is transmitted, the structure can be determined to be optically transparent, and the observation surface of the holding unit 111 may be formed of glass satisfying such a condition.

Further, for example, when the sample 210 containing cells is accommodated in the container or the like, the observation surface may be configured as a plane defined in a hollow region, or may have a hole penetrating between the container and the first light irradiation unit 112 or the image pickup unit 113. At this time, the holding unit 111 is preferred to have a mechanism for holding the container on the observation surface by supporting a part other than the bottom surface of the container.

Containers for holding the sample 210 containing cells have various forms such as a circular Petri dish and a rectangular multiwell plate, and hence the holding unit 111 is preferred to be configured to be changeable to an attachment or a fixing jig adapted to the sizes of those containers.

The holding unit 111 and the image pickup unit 113 are preferred to be arranged such that the observation surface of the holding unit 111 is perpendicular to an optical axis (OA) of the image pickup unit 113.

### (First Light Irradiation Unit 112)

The first light irradiation unit 112 irradiates the sample 210 containing cells with irradiation light that is substantially collimated parallel light.

As a specific light source for emitting the irradiation light from the first light irradiation unit 112, a white light source such as a light emitting diode (LED) light source or a halogen light source can be used.

When a wavelength band of irradiation light emitted from the light source is wide, blurring due to chromatic aberration of an optical system is caused. Thus, in order to obtain an image having high contrast, a narrower wavelength band is more preferred. In view of this, it is preferred to use an LED having a narrow emitted wavelength range, or to prepare various filters such as a narrow-band bandpass filter for an LED white light source or a halogen light source having a wide emitted wavelength range. Further, at this time, a plurality of light sources may be provided, and a configuration in which respective light sources are switched to enable light having different wavelengths to become incident on the sample 210 may be employed.

The first light irradiation unit 112 is preferred to include a telecentric optical system. When the first light irradiation unit 112 includes the telecentric optical system, uniform light that is parallel to the observation surface and small in intensity variation can be applied. Thus, it is possible to homogenize images acquired through image pickup by the image pickup unit 113, and to relatively evaluate respective cells or the like within a field of view. The term “uniform light” means a state in which a light amount distribution in the observation region is smooth, and does not locally fluctuate upward or downward.

A method of emitting parallel light from the first light irradiation unit 112 is not limited to inclusion of the telecentric optical system. A method of homogenizing emitted light is also not limited thereto, and a diffusion plate or a bundle fiber may be used. A rod lens that emits uniform light by repeatedly reflecting incident light inside a polygonal prism such as a kaleidoscope is effective as well, and hence it is also effective to use those methods in combination.

The first light irradiation unit 112 is preferred to be arranged at a position at which an angle of incidence of emitted irradiation light with respect to the observation surface is close to a Brewster angle as described later, and is particularly preferred to be arranged at a position at which the angle of incidence is the Brewster angle.

Light incident obliquely with respect to an incident surface on which light is incident is separated into two polarization components, namely, s-polarized light and p-polarized light, depending on a vibration direction of an electric field. Of those components, light in which the electric field vibrates parallel to the incident surface is referred to as “p-polarized light.”

In regard to reflectance at a boundary surface between substances having different refractive indices, the reflectance of s-polarized light continuously increases as the angle of incidence of light increases. In contrast, the reflectance of p-polarized light decreases as the angle of incidence increases, becomes zero at a specific angle, and then sharply increases. In this case, the angle of incidence of light at which the reflectance becomes zero is referred to as “Brewster angle.”

The reflectance of p-polarized light can be calculated by the Fresnel equations. When the reflectance exceeds 10%, an intensity of light scattered by the sample 210 and an intensity of light reflected by a bottom surface of an observation container accommodating the sample 210 become comparable, and contrast of an image is significantly reduced. Thus, it is preferred to set the angle of incidence so that the reflectance becomes 5% or less. When a range in which the reflectance is 5% or less is calculated based on the Fresnel equations, on a side on which the angle of incidence is smaller than the Brewster angle, the reflectance gradually increases, and hence a range down to −20 degrees from the Brewster angle is allowable. In contrast, on a side on which the angle of incidence is larger than the Brewster angle, the reflectance sharply increases, and hence the angle of incidence is desired to be limited to within +10 degrees from the Brewster angle. In view of this, the first light irradiation unit 112 is preferred to be arranged such that the angle of incidence at which light applied from the first light irradiation unit 112 is incident on the observation surface falls within a range of from −20 degrees to +10 degrees relative to the Brewster angle.

For example, it is assumed that the observation surface of the holding unit 111 is hollow and the irradiation light from the first light irradiation unit 112 is directly incident on the bottom surface of the observation container accommodating the sample 210 containing cells. When a material of the bottom surface of the observation container used at a time of image pickup is borosilicate glass and a wavelength of the incident light is 550 nm, a refractive index n_{(observation surface)} of the bottom surface of the observation container is 1.475. A refractive index nₐᵢᵣ of air is 1.0, and hence a Brewster angle θ_{B} under this image pickup condition is arctan(n_{(observation surface)}/nₐᵢᵣ)≈55.86 degrees. In this case, in order to more efficiently reduce reflection at the bottom surface of the observation container, the first light irradiation unit 112 is preferred to be arranged so that the angle of incidence at which light is incident on the bottom surface of the observation container falls within a range of from about 35 degrees to about 65 degrees.

### (Image Pickup Unit 113)

The image pickup unit 113 includes an image pickup lens 113a and an image pickup element 113b, and picks up an image by receiving the side-scattered light from the cells contained in the sample 210.

Further, the image pickup unit 113 is arranged at a specific position at least when a side-scattered light image of the sample 210 is to be acquired. That is, as illustrated in FIG. 2, the image pickup unit 113 is arranged at a position at which specularly reflected light of the irradiation light emitted from the first light irradiation unit 112 is not incident on the image pickup element 113b, the position being located on the same side as that of the first light irradiation unit 112 with reference to a plane including the observation surface of the holding unit 111. That is, an angle formed between an optical axis (OB) of the first light irradiation unit 112 and an optical axis (OA) of the image pickup unit 113 has a value at which the specularly reflected light of irradiation light from the first light irradiation unit 112 is not incident on the image pickup element 113b. The term “specularly reflected light” as used herein refers to light obtained by specularly reflecting the light applied from the first light irradiation unit 112 by the holding unit 111, the observation surface, the bottom surface of a container accommodating the sample 210, or the like.

Scattering by each cell and an internal structure thereof exhibits extremely strong forward scattering at angles (around 0°) close to a direction of the incident light. Forward scattering depends on a size and an external shape of a structure, and includes almost no information on the internal structure. For example, when cells having a diameter of 10 μm is irradiated with light having a wavelength of 550 nm, forward scattering that is from 100 times to 1,000 times or more as strong as side scattering occurs in a case in which the angle formed between the optical axis (OB) of the first light irradiation unit 112 and the optical axis (OA) of the image pickup unit 113 is from 0° to 30°, and forward scattering that is approximately more than 30 times as strong occurs even in a case in which the angle is 45°. Accordingly, when the image pickup element is arranged so that the angle is from 0° to 45°, strong forward-scattered light may be incident, thereby obscuring side-scattered light.

Meanwhile, when the angle exceeds 45°, an intensity of the forward scattering sharply decreases, and when the angle is 60°, the intensity may decrease to approximately about twice that of the side scattering. Accordingly, the image pickup element is preferred to be arranged at an angle of from 46° to 180° with respect to a direction of incidence (on the same side as that of the light irradiation unit), and this arrangement enables prevention of an increase in background light due to the forward scattering.

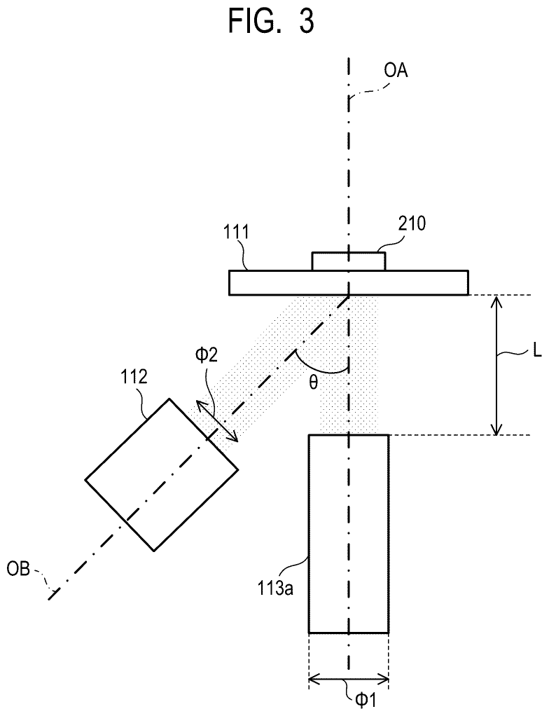

FIG. 3 is an explanatory schematic view for illustrating an example of arrangement of the first light irradiation unit 112 and the image pickup unit 113 with reference to the plane including the observation surface included in the holding unit 111.

As illustrated in FIG. 3, consideration is given to an exemplary case in which the optical axis (OA) of the image pickup unit 113 passes through a center of a light irradiation region of the sample 210 and is perpendicular to the observation surface. In this case, the angle formed between the optical axis (OA) of the image pickup unit 113 and the optical axis (OB) of the first light irradiation unit 112 is defined as θ, a distance between the observation surface and the image pickup lens 113a is defined as L, an inner diameter of the image pickup lens 113a is defined as Φ₁, and a diameter of light emitted from the first light irradiation unit 112 is defined as Φ₂. When the light applied from the first light irradiation unit 112 that is specularly reflected by the observation surface is not incident on the image pickup element 113b, θ satisfies the following expression.

L·tanθ-Φ₂/(2cosθ)>Φ₁/2

When θ satisfies this expression, light reflected from the observation surface to be incident on the image pickup element 113b can be reduced more efficiently, and an image of side-scattered light of cells to be measured can be picked up with high sensitivity.

Consideration is given to a case in which a glass-bottom dish having a cultivatable region with a diameter of 27 mm is used and 1.2×10⁶ cells that are said to correspond in number to a confluent state are cultured. In this case, when about 15,000 cells are present within one field of view, one Petri dish can be statistically represented by one field of view with an allowable error of 1% and a confidence level of 99%. The image pickup unit 113 is preferred to be able to collectively pick up an image of a plurality of cells that are statistically sufficient for one field of view to represent an entire cell culture vessel. Accordingly, the image pickup unit 113 is preferred to be able to pick up an image of a region of about 35 mm² or more.

Further, in order to distinguish two or more types of cells totaling 1.2×10⁶ cells with an allowable error of 10% and a confidence level of 90%, a field of view of about 160 mm² is required when a proportion of fewer cells is set to 0.015% of an entire amount, and a field of view of 26 mm² is required when the proportion is set to 1%. However, when it is determined that an allowable error or a confidence level is not required, or when observation is performed through use of a smaller culture vessel, the field of view may be smaller than those values.

From the above description, it is preferred that an area of an image pickup region for one field of view in the image pickup unit 113 be 35 mm² (corresponding to 7.3 mm×4.9 mm) or more, and it is more preferred that the area be 160 mm² (corresponding to 16 mm×10 mm) or more.

As the image pickup element 113b, for example, a CCD sensor or a CMOS sensor can be used. It is preferred that a size of the image pickup element 113b and a magnification of the image pickup lens 113a be adjusted so as to be able to secure the above-mentioned field-of-view region. It is also preferred that the image pickup element 113b have a large number of pixels. As the number of pixels increases, resolution of an object increases, and hence an ability to depict a shape of a minute object such as a cell is improved. Accordingly, in order to collectively pick up an image of a plurality of cells in the above-mentioned field-of-view region and to acquire side-scattered light images of the respective cells, it is preferred that side-scattered light images relating to the plurality of cells have a resolution per pixel that is sufficiently smaller than a cell, that is, 3 μm or less. In order to pick up an image of the above-mentioned image pickup region, it is preferred that the image pickup element 113b have a pixel count of at least 2,433 pixels×1,633 pixels or more, and it is more preferred that the image pickup element 113b have a pixel count of 5,333 pixels×3,333 pixels or more.

### (First Polarization Unit 114)

The first polarization unit 114 arranged between the observation surface and the first light irradiation unit 112 includes a polarizer, and selectively transmits and polarizes light in a first polarization direction of the irradiation light emitted from the first light irradiation unit 112 that does not have polarization.

It is preferred that the light in the first polarization direction transmitted through the first polarization unit 114 be p-polarized light with respect to the observation surface. The p-polarized light has a lower reflectance than that of the s-polarized light regardless of the angle of incidence, and hence the first polarization unit 114 causes only the p-polarized light to be selected from the irradiation light from the first light irradiation unit 112 and to be incident on the observation surface, to thereby be able to suppress the intensity of the reflected light. Further, as described above, when the angle of incidence of the irradiation light from the first light irradiation unit 112 with respect to the observation surface falls within a range of from −20 degrees to +10 degrees relative to the Brewster angle, the reflectance of the p-polarized light becomes further lower, and hence the reflected light can be more effectively suppressed.

As the polarizer, a polarizing plate, a polarizing prism, a polarizing film, or the like may be used. In the first polarization unit 114, a linear polarizer is used in order to transmit light in a fixed polarization direction. Further, a polarizing element of the same type as that of a polarizing element used in the second polarization unit 115 described later may be used, or a different polarizing element may be used. As the polarizer, a polarizer that transmits light emitted by the first light irradiation unit 112 is used. Further, in order to convert all the light applied to the sample 210 containing cells into linearly polarized light, a polarizer having a size that enables all the light emitted from the first light irradiation unit 112 to be polarized is used for the first polarization unit 114.

### (Second Polarization Unit 115)

The second polarization unit 115 arranged between the observation surface and the image pickup unit 113 includes a polarizer, and selectively transmits light in a second polarization direction that is perpendicular to the above-mentioned first polarization direction, the light at least being part of the light emitted from the sample 210.

The light emitted from the first light irradiation unit 112 passes through the first polarization unit 114 before being applied to the cells contained in the sample 210, and thus becomes light (polarized light) in which a component in the first polarization direction is selectively transmitted. After that, the light in which the component in the first polarization direction is selectively transmitted reaches each cell, and side-scattered light emitted from each cell is depolarized, and thereby has light in a polarization direction that passes through the second polarization unit 115. In contrast, reflected light generated after light is applied to the sample 210 containing cells maintains a main polarization component, and thus basically does not have light in a polarization direction that passes through the second polarization unit 115. Accordingly, when the second polarization unit 115 is arranged between the observation surface and the image pickup unit 113, it is possible to reduce only the reflected light that is at least part of the light emitted from the sample 210 containing cells to be incident on the image pickup element 113b, and to pick up an image of the side-scattered light emitted from the cells with a favorable S/N ratio.

As the polarizer, a polarizing plate, a polarization prism, a polarizing film, or the like may be used. In the second polarization unit 115, a linear polarizer is desired to be used in order to transmit light in a second polarization direction perpendicular to the light in the first polarization direction.

In order to prevent degradation such as image distortion, the image pickup unit 113 is preferred to further include, between the linear polarizer of the second polarization unit 115 and the image pickup element 113b, a third polarization unit including a wave plate that converts linearly polarized light into circularly polarized light. The linear polarizer and the wave plate may be separated from each other, or a structure in which the linear polarizer and the wave plate are integrated may be used as the second polarization unit 115.

It is preferred that a polarizer having a size larger than a range through which light entering the image pickup element 113b passes be used for the second polarization unit 115.

Next, an example in which the cell information acquisition system 100 illustrated in FIG. 1A, FIG. 1B, and FIG. 2 is used to carry out a cell information acquisition method according to the present disclosure is described. Operations of the respective components in the example described below may be performed based on instructions input from the input device 130 by the user, or may be automatically performed in accordance with criteria defined in advance.

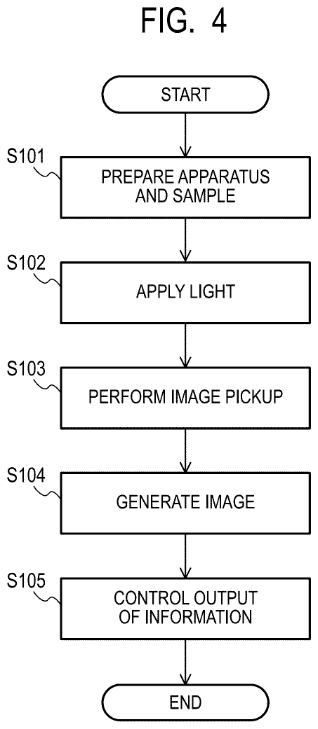

FIG. 4 is a flow chart for illustrating a flow in an example of the cell information acquisition method using the cell information acquisition system 100.

In a preparation step of Step S101, the image acquisition apparatus 110 in the cell information acquisition system 100 illustrated in FIG. 1A and FIG. 2 and the sample 210 containing cells held on the observation surface included in the holding unit 111 are prepared. In the present disclosure, there is no limitation on a cell type to be targeted, and the cells prepared in this case may be of any cell type. Further, an example including Step S101 is described in this case, but the cell information acquisition method may be a method that starts from a light irradiation step of Step S102 under a state in which the preparation step of Step S101 has already been performed.

Subsequently, in the light irradiation step of Step S102, irradiation light that is parallel light emitted from the first light irradiation unit 112 is applied to the observation surface through the first polarization unit 114. The light applied from the first light irradiation unit 112 is applied to the cells contained in the sample 210 through a region having an optically transparent structure of the observation surface, and side-scattered light is thereby emitted from the cells.

In the light irradiation step, in order to perform homogenization of an image generated in an image generation step described later and relative evaluation within the image, the first light irradiation unit 112 is preferred to irradiate the observation surface with light that is uniform, namely, small in intensity variation. In addition, as described above, in order to efficiently reduce reflected light incident on the image pickup element 113b, the first polarization unit 114 is preferred to be configured to transmit only the p-polarized light. Further, the first light irradiation unit 112 is preferred to apply light from a position at which the angle of incidence of the irradiation light with respect to the observation surface is a Brewster angle.

After that, in an image pickup step of Step S103, the side-scattered light from the cells contained in the sample 210 is received through the second polarization unit 115, and an image of the received side-scattered light is picked up by the image pickup unit 113. This image pickup step includes receiving the side-scattered light from the cells at a position at which specularly reflected light of the irradiation light is not received, on the same side as a side from which light is applied in the light irradiation step with reference to the plane including the observation surface. The term “specularly reflected light” as used herein refers to light obtained by specularly reflecting the light applied from the first light irradiation unit 112 by the observation surface, by a region of the holding unit 111 other than the observation surface, or, in a case in which the sample 210 is accommodated in a container, by the bottom surface or the like of the container.

Subsequently, in the image generation step of Step S104, an image is generated based on a signal acquired through image pickup by the image pickup unit 113.

In the cell information acquisition system 100 illustrated in FIG. 1A, the information processing device 120 includes the image generation unit 123, and an image is generated based on a signal acquired by the image pickup unit 113 by the function of the image generation unit 123. The signal acquired by the image acquisition apparatus 110 may be stored in the storage unit 126. Then, the image generation unit 123 can generate an image as well by reading out the signal stored in the storage unit 126.

Subsequently, in an output control step of Step S105, output of information regarding the cells acquired based on the signal acquired through image pickup by the image pickup unit 113 to the output device 140 is controlled.

In the cell information acquisition system 100 illustrated in FIG. 1A, the information processing device 120 includes the output control unit 124, and the output of the above-mentioned information is controlled by the function of the output control unit 124.

In the example described in this case, the information regarding the cells specifically includes an image generated by the image generation unit 123 based on the signal acquired through image pickup by the image pickup unit 113.

In the flow illustrated in FIG. 4, the example in which the image generation step of Step S104 is performed by the image generation unit 123 of the information processing device 120 has been described, but the present disclosure is not limited thereto. For example, the signal acquired by the image acquisition apparatus 110 may be transmitted to an external device by the function of the communication unit 125, and an image may be generated in the external device. In this case, the information processing device 120 can acquire the image generated in the external device through the communication unit 125, and output the image to the output device 140 by the function of the output control unit 124. When cell information can be acquired based on the signal acquired in the image pickup step, the cell information can be acquired without providing the image generation step.

### Second Embodiment

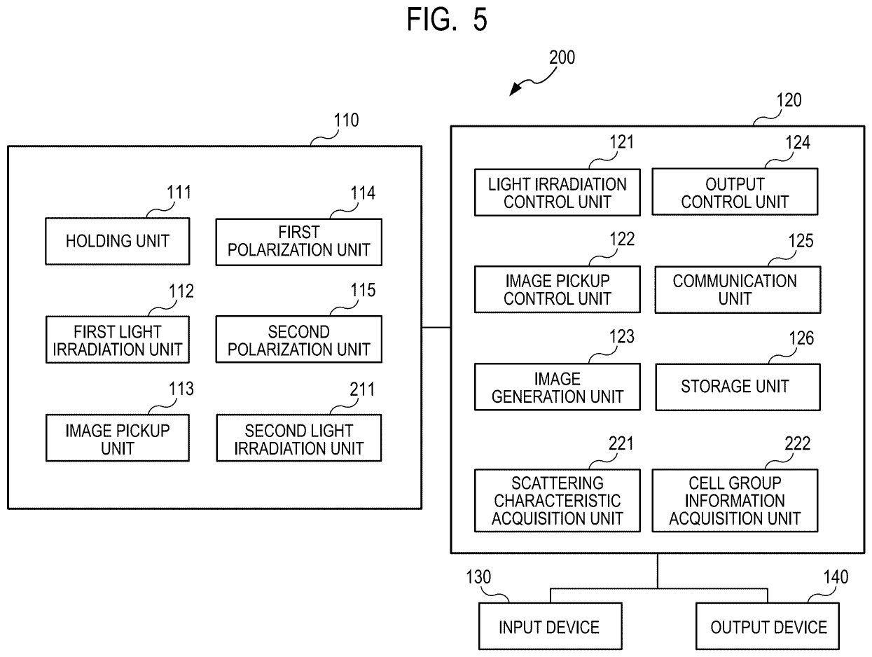

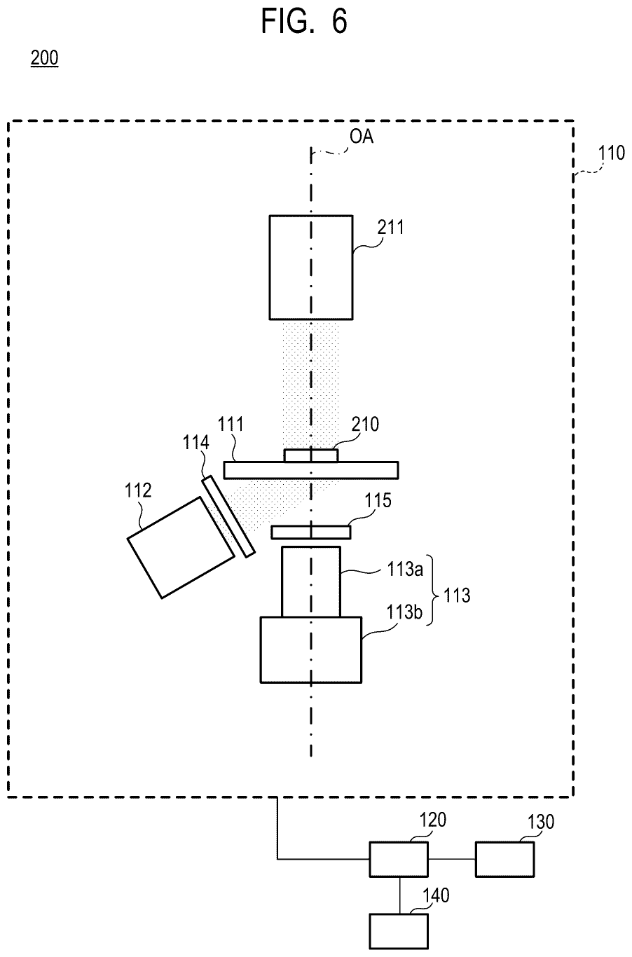

FIG. 5 is a functional block diagram for illustrating an example of a configuration of a cell information acquisition system 200 according to a second embodiment, and FIG. 6 is a schematic view for illustrating an example of an apparatus configuration of the cell information acquisition system 200 according to the second embodiment.

The cell information acquisition system 200 differs from the cell information acquisition system 100 in that the image acquisition apparatus 110 further includes a second light irradiation unit 211, and the information processing device 120 includes a scattering characteristic acquisition unit 221 and a cell group information acquisition unit 222 in addition to the image generation unit 123.

The second light irradiation unit 211 is arranged, as illustrated in FIG. 6, at a position on an opposite side to that of the image pickup unit 113 with reference to the plane including the observation surface, and is configured to irradiate the sample 210 with parallel light (substantially collimated light) that is parallel to the optical axis of the image pickup unit 113 (image pickup lens 113a). The image pickup unit 113 is further configured to receive light (transmitted light) transmitted through cells, the light being at least part of the light applied from the second light irradiation unit 211, and pick up an image of the received light. Accordingly, it is possible to acquire a transmitted-light image of cells, and to, for example, identify a cell region.

As a specific light source included in the second light irradiation unit 211, a white light source such as a light emitting diode (LED) light source or a halogen light source can be used in the same manner as in the case of the first light irradiation unit 112.

The scattering characteristic acquisition unit 221 included in the information processing device 120 is a functional portion that acquires an analysis result that is based on measured values of side-scattered light from the cells contained in the sample 210, the measured values being acquired based on the signal acquired through image pickup by the image pickup unit 113. Accordingly, the scattering characteristic acquisition unit 221 may also be referred to as “analysis result acquisition unit.”

Further, the cell group information acquisition unit 222 is a functional portion that acquires, when the sample 210 contains a plurality of cells, cell group information based on a statistical analysis result of the measured values of side-scattered light for the plurality of cells.

An example in which the cell information acquisition system 200 is used to carry out the cell information acquisition method according to the present disclosure is described below.

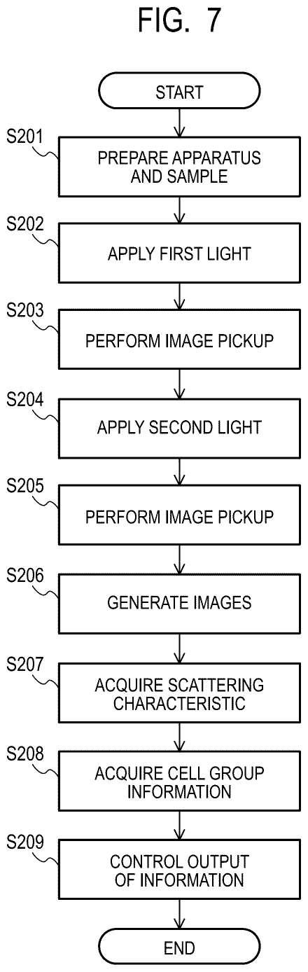

FIG. 7 is a flow chart for illustrating a flow in an example of the cell information acquisition method using the cell information acquisition system 200.

A processing step of Step S201 corresponds to the processing step of Step S101 described above, and is a preparation step of preparing the image acquisition apparatus 110 and the sample 210 containing cells held on the observation surface. In the example described in this case, it is assumed that the sample 210 contains a plurality of cells. Further, in the same manner as in Step S101, the cell information acquisition method may start from the subsequent first light irradiation step of Step S202 under the state in which the preparation step has already been performed.

The first light irradiation step of Step S202 corresponds to the processing step of Step S102 described above, and is a step of irradiating the cells contained in the sample 210 with light from the first light irradiation unit 112 through the first polarization unit 114. The light applied from the first light irradiation unit 112 is set as first light in this case.

A first image pickup step of Step S203 corresponds to the image pickup step of Step S103 described above, and is a step of receiving the side-scattered light emitted from the cells through the second polarization unit 115 and picking up an image of the received side-scattered light.

Step S204 is a second light irradiation step of irradiating the cells contained in the sample 210 with the parallel light from the second light irradiation unit 211. The light applied from the first light irradiation unit 112 is set as second light in this case.

In a second image pickup step of Step S205, the image pickup unit 113 receives the transmitted light of the cells, the transmitted light being at least part of the second light applied from the second light irradiation unit 211, and picks up an image of the received transmitted light.

Subsequently, in an image generation step of Step S206, the image generation unit 123 generates a first image based on a signal acquired through image pickup by receiving the side-scattered light of the cells that is based on the first light. In addition, the image generation unit 123 generates a second image based on a signal acquired through image pickup by receiving the transmitted light of the cells that is based on the second light.

After that, in a scattering characteristic acquisition step (analysis result acquisition step) of Step S207, the scattering characteristic acquisition unit 221 acquires an analysis result of characteristics of the side-scattered light from the cells by analyzing the measured values of the side-scattered light based on a signal acquired through image pickup in the first image pickup step.

In this case, the above-mentioned characteristics to be analyzed are, for example, at least one of a scattering intensity or a scattering pattern.

The cell information acquisition method according to the present disclosure may include an analysis step of analyzing the characteristics of the side-scattered light from the cells based on the signal acquired in the image pickup step, and, in the scattering characteristic acquisition step, an analysis result obtained in the analysis step may be acquired.

Both the scattering intensity and the scattering pattern can be obtained by analyzing an intensity of the side-scattered light based on statistical values of pixel luminance within a cell region of each cell included in the first image. The scattering intensity and the scattering pattern may be obtained by direct analysis based on a signal obtained through image pickup by receiving the side-scattered light by the image pickup unit 113.

The cell region of each cell in the first image can be acquired through use of the second image that is a transmitted-light image acquired by applying light from the second light irradiation unit 211. The image acquired by applying light from the second light irradiation unit 211 in order to identify the cell region may be a phase contrast image, a differential interference contrast image, or the like.

As the statistical values for obtaining the scattering intensity and the scattering pattern through analysis, for example, an average value, a maximum value, and a median value of a plurality of pixel values can be used. Further, as the statistical value, a gradient of pixel values in a local region within each cell region, and the like may be used. For example, histograms of oriented gradients (HoG) and the like can also be effectively used as the statistical values.

The analysis using the statistical values described above may be performed by the function of the scattering characteristic acquisition unit 221, or the scattering characteristic acquisition unit 221 may be configured to acquire an analysis result obtained by analysis performed by an external device.

Subsequently, in a cell group information acquisition step of Step S208, the cell group information acquisition unit 222 acquires the cell group information acquired by statistically analyzing the measured values of the side-scattered light for the plurality of cells.

Then, in an output control step of Step S209, the output control unit 124 controls output of information regarding the cells. In the example described in this case, the information regarding the cells includes an image in which the cell group information acquired in the cell group information acquisition step is displayed in at least any one selected from a histogram, a scatter plot, and a radar chart. The information regarding the cells can further include the first image and the second image generated in the image generation step.

The scattering intensity described above as an example of the characteristics of the side-scattered light from the cells can be used as numerical data relating to an internal structure of each cell.

While a diameter of each cell serving as an object is from about 10 μm to about 20 μm, minute structures such as organelles present inside the cell are from about several tens of nanometers to about several hundreds of nanometers. In the cell information acquisition system according to the present disclosure, side-scattered light mainly attributable to the minute structures inside the cell can be acquired based on a positional relationship between the first light irradiation unit 112 and the image pickup unit 113. Accordingly, the scattering intensity varies depending on the number of minute structures inside the cell, and when the number of minute structures is large, the scattering intensity also increases. Meanwhile, when the number of minute structures is small, or when structures inside the cell are larger by several times or more, the side-scattered light incident on the image pickup element 113b is reduced, and the intensity of a signal that is based on the side-scattered light acquired through image pickup by the image pickup unit 113 is also reduced.

The cell information acquisition system 200 according to the second embodiment can visualize and display, in the form of a histogram and a scatter plot, differences in scattering intensity and a scattering pattern that are information relating to such internal structures of each cell. Accordingly, the cell information acquisition system 200 is expected to be useful for evaluating a state of cells.

The cell information acquisition system according to the present disclosure can acquire, as information usable as the numerical data relating to the internal structure of each cell, not only the scattering intensity and the scattering pattern described above as examples but also any information that can be acquired based on the characteristics of side-scattered light of cells.

Further, embodiments according to the present disclosure are not limited to using an image generated in the image generation step. For example, the analysis may be performed by reading out an image generated in the image generation step and stored in the storage unit 126 in the past. Further, the analysis may be performed by reading, from the storage unit 126, an image generated by a method other than the methods described in the first embodiment or the second embodiment. Further, in the output control step, numerical data, histograms, scatter plots, and the like acquired and stored in the storage unit 126 in the past may be read to control the output of the read data to the output device 140.

### EXAMPLES

The present disclosure is described more specifically below through use of Examples. The present disclosure is not limited to the following Examples.

### Example 1

### (Sample)

In Example 1, Chinese hamster lung-derived cells (CHL-YN) were used. A flask (Thermo Fisher Scientific: Nunc EasYFlask 25 cm²) containing 5 mL of a culture medium (Sigma-Aldrich: Ex-cell CD CHO Fusion) was used, and the cells were cultured with shaking in an incubator at a temperature of 37° C. with 5% carbon dioxide. At a time of observation, a small amount was taken from the culture medium in the flask, and suspension was performed in PBS (Dulbecco's Phosphate Buffered Saline) to prepare the sample 210 containing cells. After that, the prepared sample 210 was placed in a Φ35 mm glass-bottom dish (Matsunami: GLASS BOTTOM DISH) and allowed to settle.

### (Image Acquisition)

In Example 1, the cell information acquisition system 100 having the same apparatus configuration as that illustrated in FIG. 2 was used. An attachment capable of placing a general-purpose φ35 mm dish for cell observation (a container having a recessed bottom surface made of glass (hereinafter also referred to simply as “container”)) was provided on the observation surface of the holding unit 111, and the container including the above-mentioned sample 210 was placed.

The sample 210 was irradiated with light through use of an illumination system that combined a high-brightness LED light source that emits light having a plurality of wavelengths including light having a wavelength of 525 nm, a quartz bundle fiber, and a telecentric lens. The telecentric lens was attached to an output end of the quartz bundle fiber, and it was possible to irradiate the object with the parallel light even when the emitted light was applied obliquely to the object.

Further, in order to reduce reflected light from the bottom surface of the container that becomes incident on the image pickup unit 113, the light was applied from the first light irradiation unit 112 positioned on the same side as that of the image pickup unit 113 with reference to the plane including the holding unit 111 (observation surface) such that the angle of incidence of the light incident on the bottom surface of the container was about 45 degrees.

Further, the first polarization unit 114 includes a film-type linear polarizer that transmits light in the first polarization direction that is at least part of the light having a wavelength of 525 nm, and converted the emitted light into p-polarized light in order to reduce the reflected light from the bottom surface of the container when the light is applied. In order to convert all the light applied to the sample 210 into linearly polarized light, a polarizer having a diameter larger than the diameter of light emitted from the first light irradiation unit 112 was used.

For the second polarization unit 115, a film-type linear polarizer that transmits light in a second polarization direction that is at least part of the light having a wavelength of 525 nm was used, the second polarization direction being perpendicular to the first polarization direction of the light that has passed through the first polarization unit 114.

Further, in order to prevent degradation such as image distortion, a polarization filter in which the above-mentioned linear polarizer and a wavelength plate that converts linearly polarized light into circularly polarized light are integrated was employed as the second polarization unit 115. A polarization filter larger than an entrance aperture of the image pickup lens 113a included in the image pickup unit 113 was used for the second polarization unit 115.

Further, in Example 1, a commercially available mirrorless single-lens digital camera including a full-frame 8K-pixel color CMOS sensor of 36 mm×24 mm mounted as the image pickup element 113b was used as the image pickup unit 113. In addition, as a telecentric lens for image pickup, a commercially available telecentric lens having a magnification of 2× that can be mounted in the image pickup unit 113 was employed. As a result, an image having a field-of-view size of 18 mm×12 mm and a pixel count of 8,191 pixels×5,463 pixels was acquired. A resolution per pixel was about 2.2 μm, which was sufficiently smaller than a cell having a diameter of about 10 μm.

### Reference Example 1

As Reference Example 1, in order to confirm effects of the first polarization unit 114 and the second polarization unit 115 used in Example 1, an image was acquired through use of a system having a configuration in which the polarizers were removed from the configuration of Example 1. In an optical system in which the polarizers were removed from the configuration of Example 1, image brightness increases, and hence, in Reference Example 1 as well, image pickup was performed by adjusting an exposure time and ISO so that an image having the same brightness as that of an image acquired in Example 1 was able to be acquired.

### <Results>

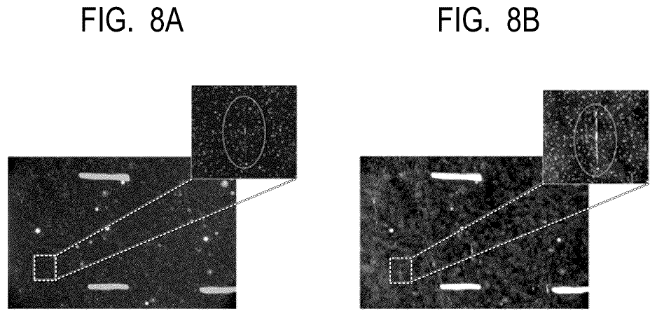

An image acquired in Example 1 is shown in FIG. 8A, and an image acquired in Reference Example 1 is shown in FIG. 8B.

From a comparison between FIG. 8A and FIG. 8B, it can be understood that, when no polarizer is used, reflected light originating from the container containing the sample 210 appears as linear noise in the image. Meanwhile, in Example 1 using the polarizers, the reflected light incident on the image pickup unit 113 can be reduced, and hence it was able to be confirmed that the noise in the above-mentioned image is also reduced. The above-mentioned difference between the respective images is particularly evident in parts within the rectangular regions at the lower left portions of FIG. 8A and FIG. 8B.

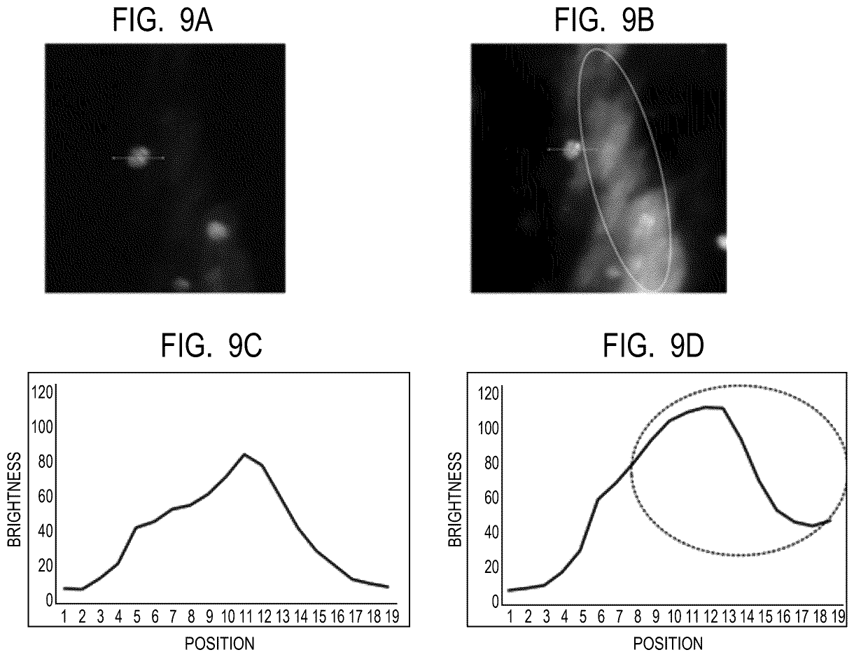

Next, an enlarged image of one cell in an image acquired in Example 1 using the cell information acquisition system according to the present disclosure is shown in FIG. 9A, and an enlarged image of one cell in an image acquired in Reference Example 1 is shown in FIG. 9B.

It was able to be confirmed that, in FIG. 9B, a reflected-light component appears as noise in the region surrounded by the solid line.

In addition, brightness profiles on lines drawn so as to be superimposed on the cell images of FIG. 9A and FIG. 9B for the same cell are shown in FIG. 9C and FIG. 9D, respectively. FIG. 9C shows a brightness profile acquired from the image shown in FIG. 9A, and FIG. 9D shows a brightness profile acquired from the image shown in FIG. 9B.

The region surrounded by the dotted line in the brightness profile of FIG. 9D indicates an increase in the brightness (of background light) due to the reflected-light component.

From those results, it was confirmed that the reflected light entering the image pickup element 113b can be reduced by the image acquisition apparatus 110 including the first polarization unit 114 and the second polarization unit 115, and it is expected that transmitted light can be reduced in the same manner.

### Reference Example 2

### (Sample)

As the cells, peripheral blood mononuclear cells (HPBMC: 47639) that are known to include a mixture of cells having different side-scattered light intensities were used.

The cells were seeded in a 24-well plate containing 1 mL of a culture medium per well, and statically cultured in an incubator at 37° C. with 5% carbon dioxide. On the day following the start of the culture, cells from one well were entirely collected and centrifuged through use of a centrifuge (300×g, 4° C., and 5 minutes), followed by removal of a supernatant, and suspension was performed in 5 mL of the culture medium.

Next, a flow cytometer capable of sorting cells based on a side-scattered light intensity thereof was used to sort, from a suspension of the peripheral blood mononuclear cells, a cell group having strong side-scattered light and a cell group having weak side-scattered light. The flow cytometer is a publicly-known technology capable of measuring the side-scattered light intensity of cells that reflects complexity of internal structures of the cells, and the two cell groups sorted through use of the flow cytometer described above can be said to be cell groups sorted based on a difference in the internal structures.

Then, a Φ35-mm glass-bottom dish (Matsunami: GLASS BOTTOM DISH) was divided into two regions by a device made of silicone rubber, and each of the cell groups was placed into a corresponding divided region and allowed to settle.

### (Image Acquisition)

Images were acquired in the same manner as in Example 1, except that the cell information acquisition system 200 illustrated in FIG. 6 was used.

### (Image Processing)

In Reference Example 2, respective cell regions were acquired through use of a transmitted-light image of a cell sample. The cell regions obtained in this case were merged with a side-scattered light image, and for each individual cell, the statistical values of the cell region were acquired as the scattering intensity of the cell.

As the statistical values, an area of a cell region, and an average value, a maximum value, a median value, and the like of pixel luminance of a scattered light image were acquired. Further, RGB components of the generated scattered light image were separated, and only the G component was used.

In Reference Example 2, a histogram was drawn with an average value of the pixel luminance of the scattered light image within each cell region on a horizontal axis and a frequency on a vertical axis.

### <Results>

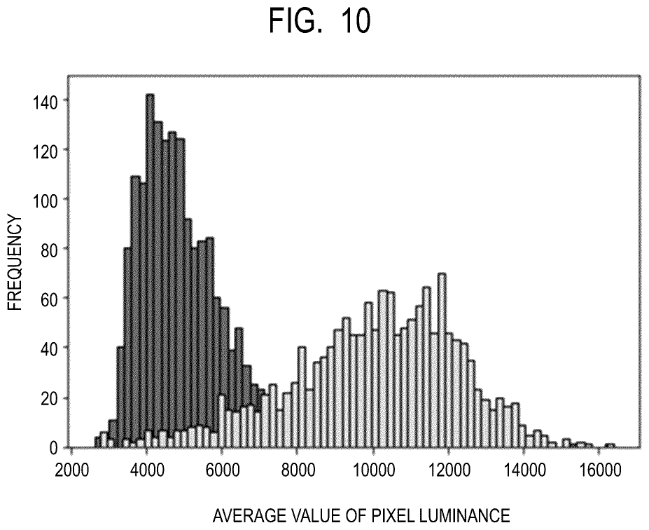

The histogram that was drawn is shown in FIG. 10.

The cell group having weak side-scattered light and the cell group having strong side-scattered light that were sorted through use of the flow cytometer are shown in dark gray and in light gray, respectively.

In this Reference Example, the first light irradiation unit 112 positioned on the same side as that of the image pickup unit 113 with reference to the plane including the holding unit 111 applies light such that the angle of incidence at which the light is incident on a sample surface of the object is about 45 degrees. Accordingly, the image acquisition apparatus 110 has a configuration in which the reflected light from cells and the observation container holding the cells is reduced and, of the light incident on the image pickup element 113b, the scattered light attributable to the minute internal structures of the cells is stronger than the reflected light from surfaces of the cells.

Further, the image acquisition apparatus 110 includes the first polarization unit 114 and the second polarization unit 115, and reduces the reflected light incident on the image pickup unit 113 from cells and from the observation container holding the cells.

As a result of analyzing side-scattered light images of the cells acquired by the cell information acquisition system 200 having such a configuration, a difference in the pixel luminance of cell regions was observed, as shown in FIG. 10, between the two cell groups separated based on the difference in the internal structures of the cells through use of the flow cytometer. In view of this, it is considered that information relating to the internal structures of cells can be acquired from the side-scattered light images acquired in this system.

In the cell information acquisition system according to the present disclosure, general-purpose apparatus can be used as the image acquisition apparatus 110 and the information processing device 120 as compared to the flow cytometer. Accordingly, the cell information acquisition system is simpler, and side-scattered light signals from a large number of cells can be acquired in a single image pickup, thereby enabling the information relating to the internal structures of the cells to be acquired more rapidly. Further, through use of the cell information acquisition system and the cell information acquisition method according to the present disclosure, for example, it may be possible to acquire information on adherent cells or other cells under culture and determine whether or not to continue the culture based on the acquired information, and may be possible to change a culture environment.

### Reference Example 3

In Reference Example 3, HOG feature amounts of cells were analyzed as the scattering pattern of the cells.

### (Sample)

In Reference Example 3, Chinese hamster lung-derived cells (CHL-YN) were used.

A flask (Thermo Fisher Scientific: Nunc EasYFlask 25 cm²) containing 5 mL of a culture medium (Sigma-Aldrich: Ex-cell CD CHO Fusion) was used, and the cells were cultured with shaking in an incubator at a temperature of 37° C. with 5% carbon dioxide.

At the time of observation, a small amount was taken from the culture medium in the flask, centrifuged through use of the centrifuge (300×g, 4° C., and 5 minutes), followed by removal of a supernatant, and suspension was performed in PBS (Dulbecco's Phosphate Buffered Saline). Next, a flow cytometer capable of sorting cells based on a side-scattered light intensity thereof was used to sort, from a suspension of the CHL-YN cells, a cell group having strong side-scattered light and a cell group having weak side-scattered light. Then, a Φ35-mm glass-bottom dish (Matsunami: GLASS BOTTOM DISH) was divided into two regions by a device made of silicone rubber, and each of the cell groups was placed into a corresponding divided region and allowed to settle.

### (Image Acquisition)

Images were acquired in the same manner as in Reference Example 2.

### (Image Processing)

In Reference Example 3, respective cell regions were acquired through use of a transmitted-light image of a cell sample.

Next, from the scattered light image, a square region centered on the center of each cell region was extracted, each square region was divided at intervals of 20 degrees, and the HOG feature amounts in each angular direction were acquired. The term “HOG feature amounts” as used herein refers to feature vectors representing edge intensities based on gradients of pixel luminance.

Then, for the two cell groups sorted through use of the flow cytometer as described above, values obtained by averaging the HOG feature amounts of the respective cells for the respective angular directions were calculated, and a radar chart plotted for the respective angular directions was created. The averaging was performed for 3,151 cells in the cell group having strong side-scattered light acquired through use of the flow cytometer, and for 1,829 cells in the cell group having weak side-scattered light acquired through use of the flow cytometer.

### <Results>

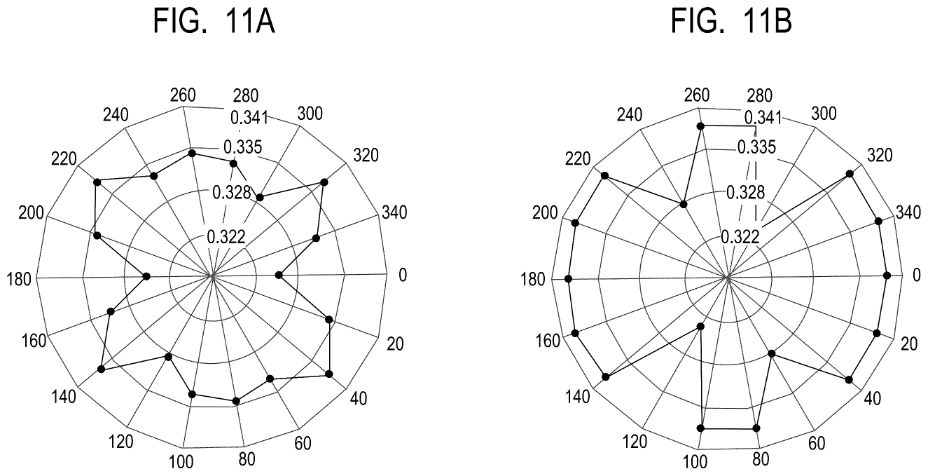

The created radar charts are shown in FIG. 11A and FIG. 11B. FIG. 11A shows the radar chart of the cell group having strong side-scattered light sorted through use of the flow cytometer, and FIG. 11B shows the radar chart of the cell group having weak side-scattered light sorted through use of the flow cytometer. The numerical values written outside each radar chart indicate angular directions (degrees) at which feature vectors were acquired, and the numerical values written inside each radar chart indicate relative values of magnitudes of the feature vectors. The light was caused to be incident from a direction of 180 degrees of the radar charts.

As a result of comparing the radar charts of the respective cell groups that were acquired, when the side-scattered light was strong, the magnitudes of the feature vectors at the respective angles did not greatly vary. Meanwhile, when the side-scattered light was weak, a tendency in which the feature vectors in a direction of specular reflection and a direction of transmission with respect to the direction of incidence of the light became larger was observed. From those results, it was able to be confirmed that it is possible to acquire the scattering pattern of the cells through use of the cell information acquisition system according to the present disclosure.

Any one of the embodiments described above is merely an example of implementation for carrying out the present invention, and the technical scope of the present invention is not to be construed in a limiting manner due to those embodiments. That is, the present invention can be carried out in various forms without departing from the technical idea of the invention or major features of the invention. For example, an embodiment in which a configuration of a part of any one of the embodiments is added to another embodiment or an embodiment in which a configuration of a part of any one of the embodiments is substituted with a configuration of a part of another embodiment is also to be understood as an embodiment to which the present invention is applicable. Specifically, for example, an aspect in which the image acquisition apparatus 110 in the first embodiment includes the second light irradiation unit 211 described in the second embodiment is also to be construed as an embodiment according to the present disclosure.

Embodiments according to the present disclosure include the following configurations and methods.

### (Configuration 1)

A cell information acquisition system including:
a holding unit including an observation surface that is light-transmittable, the holding unit being configured to hold a sample containing a cell on the observation surface;
a first light irradiation unit configured to irradiate the observation surface with irradiation light that is parallel light;
an image pickup unit including an image pickup element, the image pickup unit being configured to receive side-scattered light from the cell and pick up an image of the side-scattered light;
a first polarization unit arranged between the observation surface and the first light irradiation unit, and configured to selectively transmit light in a first polarization direction, the light being at least part of the irradiation light; and
a second polarization unit arranged between the observation surface and the image pickup unit, and configured to selectively transmit light in a second polarization direction perpendicular to the first polarization direction, the light being at least part of light from the sample,
wherein the image pickup unit is arranged at a position at which specularly reflected light of the irradiation light is not incident on the image pickup element, the position being located on the same side as a side on which the first light irradiation unit is arranged with reference to a plane including the observation surface.

### (Configuration 2)

The cell information acquisition system according to Configuration 1, wherein the light in the first polarization direction is p-polarized light that is parallel to the observation surface.

### (Configuration 3)

The cell information acquisition system according to Configuration 1, wherein the first light irradiation unit is arranged at such a position that an angle of incidence of the irradiation light with respect to the observation surface falls within a range of from −20 degrees to +10 degrees relative to a Brewster angle.

### (Configuration 4)

The cell information acquisition system according to any one of Configurations 1 to 3, wherein the first light irradiation unit is arranged at such a position that an angle of incidence of the irradiation light with respect to the observation surface corresponds to a Brewster angle.

### (Configuration 5)

The cell information acquisition system according to any one of Configurations 1 to 4, characterized in that the first light irradiation unit includes a telecentric optical system.

### (Configuration 6)

The cell information acquisition system according to any one of Configurations 1 to 5, characterized by further including an output control unit configured to control output of information regarding the cell acquired based on a signal acquired through image pickup by the image pickup unit.

### (Configuration 7)

The cell information acquisition system according to Configuration 6, wherein the information regarding the cell includes an image generated based on the signal acquired through image pickup by the image pickup unit.

### (Configuration 8)

The cell information acquisition system according to any one of Configurations 1 to 7, further including an analysis result acquisition unit configured to acquire an analysis result of a characteristic of the side-scattered light from the cell based on a signal acquired through image pickup by the image pickup unit.

### (Configuration 9)

The cell information acquisition system according to Configuration 8, wherein the characteristic of the side-scattered light is at least one of a scattering intensity or a scattering pattern.

### (Configuration 10)

The cell information acquisition system according to any one of Configurations 1 to 9, further including a second light irradiation unit arranged at a position on an opposite side to a side on which the image pickup unit is arranged with reference to a plane including the observation surface, and configured to irradiate the sample with parallel light that is parallel to an optical axis of the image pickup unit,
wherein the image pickup unit is further configured to receive light transmitted through the cell, the light being at least part of the parallel light applied from the second light irradiation unit, and pick up an image of the received light.

### (Configuration 11)

### The Cell Information Acquisition System According to Any One of Configurations 8 to 10,

wherein the sample includes a plurality of cells, and
wherein the cell information acquisition system further includes a cell group information acquisition unit configured to acquire cell group information that is based on a statistical analysis result of the side-scattered light from the plurality of cells.

### (Configuration 12)

The cell information acquisition system according to Configuration 11, further including an output control unit configured to control output of an image in which the cell group information is displayed in at least any one selected from a histogram, a scatter plot, and a radar chart.

### (Method 1)

A cell information acquisition method including:
a light irradiation step of irradiating an observation surface that is light-transmittable and that holds a sample containing a cell with irradiation light that is parallel light through a first polarization unit configured to selectively transmit light in a first polarization direction; and
an image pickup step of receiving light including side-scattered light from the cell that has passed through a second polarization unit configured to selectively transmit light in a second polarization direction perpendicular to the first polarization direction, at a position at which specularly reflected light of the irradiation light is not received, on the same side as a side from which light is emitted in the light irradiation step with reference to a plane including the observation surface.

### (Method 2)

The cell information acquisition method according to Method 1, further including an analysis result acquisition step of acquiring an analysis result of a characteristic of the side-scattered light from the cell based on a signal acquired in the image pickup step.

### (Method 3)

The cell information acquisition method according to Method 1 or 2, further including an analysis step of analyzing a characteristic of the side-scattered light from the cell based on a signal acquired in the image pickup step.

### (Method 4)

The cell information acquisition method according to Method 2,
wherein the sample includes a plurality of the cells, and
wherein the cell information acquisition method further includes a cell group information acquisition step of acquiring cell group information acquired by statistically analyzing characteristics of the side-scattered light for the plurality of the cells, based on the analysis result acquired in the analysis result acquisition step.

### (Method 5)

The cell information acquisition method according to Method 2, further including an output control step of performing control of outputting information regarding the cell that is based on the analysis result acquired in the analysis result acquisition step.

### (Method 6)

The cell information acquisition method according to Method 4, further including an output control step of performing control of outputting information regarding the cell that is based on the cell group information acquired in the cell group information acquisition step.

According to the present disclosure, it is possible to provide the cell information acquisition system and the cell information acquisition method that enable, for a sample containing cells, acquisition and analysis of side-scattered light signals from the cells with high accuracy.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-032149, filed Feb. 28, 2025, which is hereby incorporated by reference herein in its entirety.

What is claimed is:

1. A cell information acquisition system comprising:
a holding unit including an observation surface that is light-transmittable, the holding unit being configured to hold a sample containing a cell on the observation surface;
a first light irradiation unit configured to irradiate the observation surface with irradiation light that is parallel light;
an image pickup unit including an image pickup element, the image pickup unit being configured to receive side-scattered light from the cell and pick up an image of the side-scattered light;
a first polarization unit arranged between the observation surface and the first light irradiation unit, and configured to selectively transmit light in a first polarization direction, the light being at least part of the irradiation light; and
a second polarization unit arranged between the observation surface and the image pickup unit, and configured to selectively transmit light in a second polarization direction perpendicular to the first polarization direction, the light being at least part of light from the sample,
wherein the image pickup unit is arranged at a position at which specularly reflected light of the irradiation light is not incident on the image pickup element, the position being located on the same side as a side on which the first light irradiation unit is arranged with reference to a plane including the observation surface.

2. The cell information acquisition system according to claim 1, further comprising:
a mounting unit for the first polarization unit; and
a mounting unit for the second polarization unit,
wherein the first polarization unit is mounted in the mounting unit for the first polarization unit, and the second polarization unit is mounted in the mounting unit for the second polarization unit.

3. The cell information acquisition system according to claim 2, further comprising a control unit,
wherein the control unit is configured to arrange the first polarization unit mounted in the mounting unit for the first polarization unit between the observation surface and the first light irradiation unit, and arrange the second polarization unit mounted in the mounting unit for the second polarization unit between the observation surface and the image pickup unit.

4. The cell information acquisition system according to claim 1, wherein the light in the first polarization direction comprises p-polarized light that is parallel to incident surface.

5. The cell information acquisition system according to claim 1, wherein the first light irradiation unit is arranged at such a position that an angle of incidence of the irradiation light with respect to the observation surface falls within a range of from −20 degrees to +10 degrees relative to a Brewster angle.

6. The cell information acquisition system according to claim 1, wherein the first light irradiation unit is arranged at such a position that an angle of incidence of the irradiation light with respect to the observation surface corresponds to a Brewster angle.

7. The cell information acquisition system according to claim 1, wherein the first light irradiation unit includes a telecentric optical system.

8. The cell information acquisition system according to claim 1, further comprising an output control unit configured to control output of information regarding the cell acquired based on a signal acquired through image pickup by the image pickup unit.

9. The cell information acquisition system according to claim 8, wherein the information regarding the cell includes an image generated based on the signal acquired through image pickup by the image pickup unit.

10. The cell information acquisition system according to claim 1, further comprising an analysis result acquisition unit configured to acquire an analysis result of a characteristic of the side-scattered light from the cell based on a signal acquired through image pickup by the image pickup unit.

11. The cell information acquisition system according to claim 10, wherein the characteristic of the side-scattered light comprises at least one of a scattering intensity or a scattering pattern.

12. The cell information acquisition system according to claim 10, further comprising a second light irradiation unit arranged at a position on an opposite side to a side on which the image pickup unit is arranged with reference to a plane including the observation surface, and configured to irradiate the sample with parallel light that is parallel to an optical axis of the image pickup unit,
wherein the image pickup unit is further configured to receive light transmitted through the cell, the light being at least part of the parallel light applied from the second light irradiation unit, and pick up an image of the received light.

13. The cell information acquisition system according to claim 10,
wherein the sample includes a plurality of cells, and
wherein the cell information acquisition system further comprises a cell group information acquisition unit configured to acquire cell group information that is based on a statistical analysis result of measured values of side-scattered light from the plurality of cells.

14. The cell information acquisition system according to claim 13, further comprising an output control unit configured to control output of an image in which the cell group information is displayed in at least any one selected from a histogram, a scatter plot, and a radar chart.

15. The cell information acquisition system according to claim 1, further comprising:
a first photographing mode; and
a second photographing mode,
wherein the first photographing mode comprises an autofluorescence photographing mode, and
wherein the second photographing mode comprises a side-scattered light measurement mode.

16. The cell information acquisition system according to claim 15, wherein the first photographing mode serves as a photographing mode in an initial state.

17. The cell information acquisition system according to claim 15, further comprising a display control unit,
wherein the display control unit is configured to display, on a display unit, an operation region for receiving switching of a photographing mode together with information relating to a selected photographing mode.

18. A cell information acquisition method comprising:
a light irradiation step of irradiating an observation surface that is light-transmittable and that holds a sample containing a cell with irradiation light that is parallel light through a first polarization unit configured to selectively transmit light in a first polarization direction; and
an image pickup step of receiving light including side-scattered light from the cell that has passed through a second polarization unit configured to selectively transmit light in a second polarization direction perpendicular to the first polarization direction, at a position at which specularly reflected light of the irradiation light is not received, on the same side as a side from which light is emitted in the light irradiation step with reference to the observation surface.

19. The cell information acquisition method according to claim 18, wherein the light irradiation step includes applying light by arranging a first light irradiation unit at such a position that an angle of incidence of the irradiation light with respect to the observation surface falls within a range of from −20 degrees to +10 degrees relative to a Brewster angle exhibited when the irradiation light is incident on the observation surface.

20. The cell information acquisition method according to claim 18, further comprising an analysis result acquisition step of acquiring an analysis result of a characteristic of side-scattered light from the cell based on a signal acquired in the image pickup step.
